(19) United States
(12) Patent Application Publication
(10) Pub. No.: US 2012/0296010 A1
(43) Pub. Date: Nov. 22, 2012

(54) ENCAPSULATING SHEET AND ELECTRONIC DEVICE

(75) Inventors: Yuusaku SHIMIZU, Osaka (JP); Eiji TOYODA, Osaka (JP); Tomoo YAMAGUCHI, Osaka (JP); Yasunobu INA, Osaka (JP)

(73) Assignee: NITTO DENKO CORPORATION, Osaka (JP)

(21) Appl. No.: 13/475,636

(22) Filed: May 18, 2012

(30) Foreign Application Priority Data
May 20, 2011 (JP) 2011-113989

(51) Int. Cl. C09D 163/02

(52) U.S. Cl. 523/400

(57) ABSTRACT

An encapsulating sheet is obtained by subjecting a kneaded material to plastic working, the kneaded material including an epoxy resin represented by General Formula (1) below, a curing agent, and an inorganic filler,

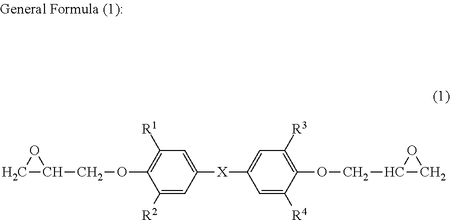

(where R¹ to R⁴ are the same or different, and each represents a methyl group or a hydrogen atom; and X represents —CH₂—, —O—, or —S—).

### CROSS-REFERENCE TO RELATED APPLICATION

The present application claims priority from Japanese Patent Application No. 2011-113989 filed on May 20, 2011, the contents of which are hereby incorporated by reference into this application.

### BACKGROUND OF THE INVENTION

1. Field of the Invention

The present invention relates to an encapsulating sheet and an electronic device, particularly to an encapsulating sheet used for encapsulating various industrial products, and to an electronic device including electronic components encapsulated by the encapsulating sheet.

2. Description of Related Art

Recently, an encapsulating sheet excellent in handleability is widely used for encapsulating electronic components such as semiconductor elements, condensers, and resistance elements on mounting substrates.

As such an encapsulating sheet, for example, Japanese Unexamined Patent Publication No. 2006-19714 and Japanese Unexamined Patent Publication No. 2003-17979 have proposed a gelled epoxy resin sheet: the gelled epoxy resin sheet is formed by applying, on a film, a varnish (composition) prepared by blending an epoxy resin, a curing agent, a gelling agent (flexibilizer), a filler, etc.

### SUMMARY OF THE INVENTION

The gelled epoxy resin sheet described in Japanese Unexamined Patent Publication No. 2006-19714 and Japanese Unexamined Patent Publication No. 2003-17979 is produced, as described above, by preparing a varnish (composition) by blending the various components, and then thereafter forming a coating by applying the varnish on a film.

However, in such production, when the mixing ratio of the filler in the gelled epoxy resin sheet is at a certain value or more, the coating may not be formed when the varnish is applied on the film.

Therefore, sufficient improvement in performance of the gelled epoxy resin sheet may not be achieved.

Also, in an encapsulating sheet such as the gelled epoxy resin sheet described in Japanese Unexamined Patent Publication No. 2006-19714 and Japanese Unexamined Patent Publication No. 2003-17979, a large amount of flexibilizer (gelling agent) is sometimes blended in order to obtain flexibility that allows use as an encapsulating sheet. However, when a large amount of flexibilizer is blended in the encapsulating sheet, there are disadvantages such as decrease in adhesiveness and heat resistance of the encapsulating sheet.

Thus, an object of the present invention is to provide an encapsulating sheet in which the mixing ratio of the filler can be increased, and that can achieve improvement in adhesiveness and heat resistance; and an electronic device including electronic components encapsulated by the encapsulating sheet.

An encapsulating sheet of the present invention is obtained by subjecting a kneaded material to plastic working, the kneaded material including an epoxy resin represented by General Formula (1) below, a curing agent, and an inorganic filler,

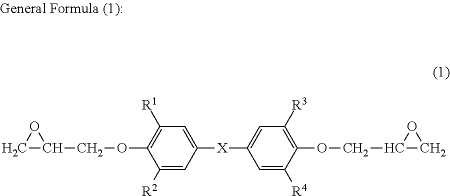

(where R¹ to R⁴ are the same or different and each represents a methyl group or a hydrogen atom; and X represents —CH₂—, —O—, or —S—).

In the present invention, it is preferable that the curing agent is a phenol resin having a biphenyl aralkyl structure.

In the present invention, it is preferable that the kneaded material further includes a flexibilizer kneaded therein.

In the present invention, it is preferable that the flexibilizer is an elastomer having a styrene structure.

An electronic device of the present invention is obtained by encapsulating an electronic component by curing the above-described encapsulating sheet.

An encapsulating sheet of the present invention is obtained by subjecting a kneaded material to plastic working, and the kneaded material is obtained by kneading an epoxy resin represented by General Formula (1) described above, a curing agent, and an inorganic filler.

That is, an encapsulating sheet is formed without applying, on a film, a varnish containing an epoxy resin and an inorganic filler, and therefore the mixing ratio of the inorganic filler can be increased.

Thus, sufficient improvement in performance of an encapsulating sheet can be achieved.

An encapsulating sheet of the present invention can achieve improvement in adhesiveness and heat resistance because of its sufficient flexibility without blending a large amount of flexibilizer.

Therefore, an encapsulating sheet of the present invention allows increase in the mixing ratio of the inorganic filler, and achieves improvement in adhesiveness and heat resistance.

### BRIEF DESCRIPTION OF THE DRAWINGS

FIG. 1 is a process diagram illustrating steps of producing an electronic device by encapsulating an electronic component with an encapsulating sheet in an embodiment of the present invention,

(a) illustrating a step of disposing an electronic component on a mounting substrate,

(b) illustrating a step of disposing the encapsulating sheet on the electronic component, and

(c) illustrating a step of heating and curing the encapsulating sheet.

### DETAILED DESCRIPTION OF THE INVENTION

An encapsulating sheet of the present invention is used for encapsulation of various industrial products, and is formed from a kneaded material in sheet form.

The kneaded material contains an epoxy resin represented by General Formula (1) below, a curing agent, and an inorganic filler.

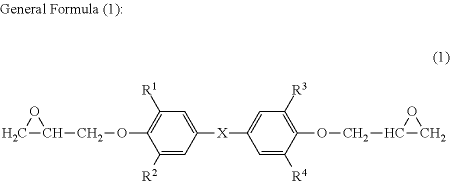

(where R¹ to R⁴ are the same or different and each represents a methyl group or a hydrogen atom; and X represents —CH₂—, —O—, or —S—).

R¹ to R⁴ in general formula (1) shown above each represents a methyl group or a hydrogen atom attached to a benzene ring, and preferably, all of R¹ to R⁴ are methyl groups or hydrogen atoms.

Examples of such epoxy resins include bisphenol F epoxy resins represented by Chemical Formulas (2) to (4) below; 4,4′-thio bisphenol epoxy resins represented by Chemical Formulas (5) to (7) below; and 4,4′-oxybisphenol epoxy resins represented by Chemical Formulas (8) to (10) below.

Of these epoxy resins, in view of pliability, preferable examples are bisphenol F epoxy resins represented by Chemical Formula (2) below, 4,4′-thio bisphenol epoxy resins represented by Chemical Formula (5) below, and 4,4′-oxybisphenol epoxy resin represented by Chemical Formula (8) below, and in view of less tackiness, a more preferable example is bisphenol F epoxy resin represented by Chemical Formula (2) below.

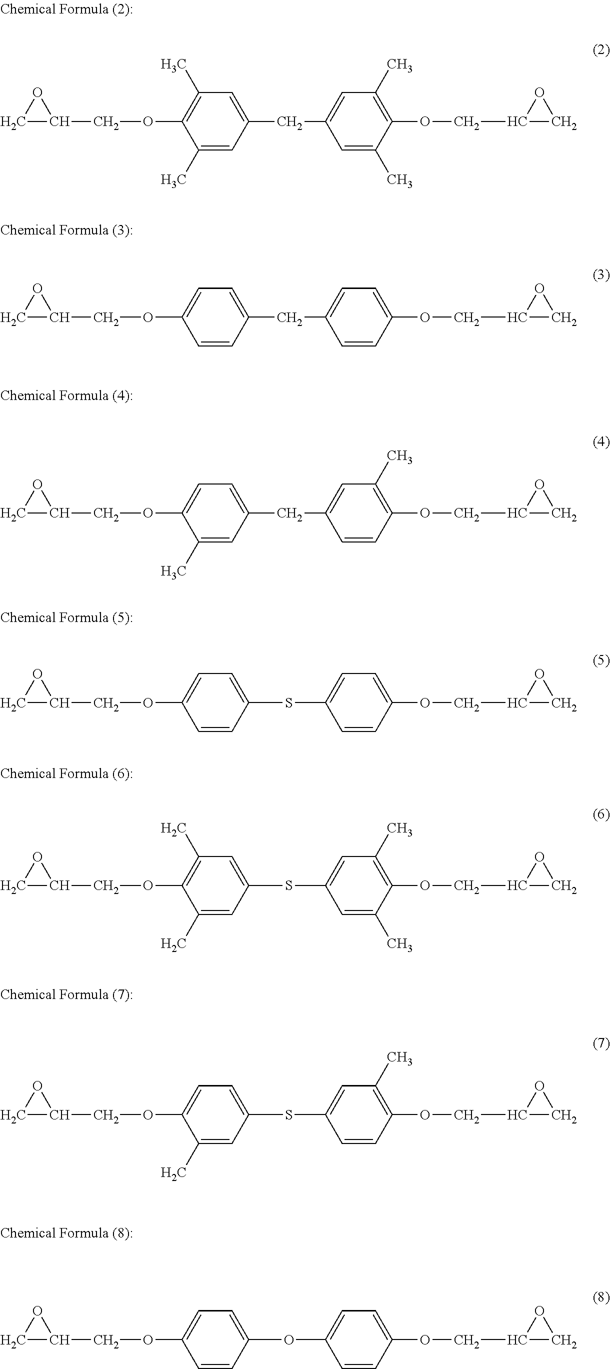

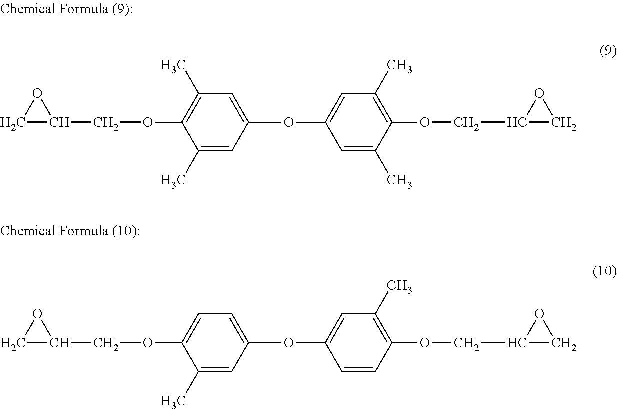

These epoxy resins may be used singly or in combination.

Such an epoxy resin has an epoxy equivalent of, for example, 90 to 800 g/eq, preferably 100 to 500 g/eq.

Such an epoxy resin has a softening point of, for example, 30 to 100° C., preferably 40 to 90° C.

The proportion of such an epoxy resin content relative to 100 parts by mass of the kneaded material is, for example, 1 to 50 parts by mass, and in view of flexibility of the encapsulating sheet, preferably 3 to 20 parts by mass, more preferably 4 to 8 parts by mass.

The curing agent is a curing agent for the above-described epoxy resin, and is not particularly limited. Examples of curing agents include phenol resin, an acid anhydride compound, and an amine compound.

Examples of phenol resins include phenol novolak resin, phenol aralkyl resin, biphenyl aralkyl resin (phenol resin having a biphenyl aralkyl structure), dicyclopentadiene phenol resin, cresol novolak resin, and resol resin.

Examples of acid anhydride compounds include phthalic anhydride, maleic anhydride, tetrahydrophthalic anhydride, hexahydrophthalic anhydride, methyl nadic anhydride, pyromelletic anhydride, dodecenylsuccinic anhydride, dichlorosuccinic anhydride, benzophenonetetracarboxylic anhydride, and chlorendic anhydride.

Examples of amine compounds include ethylene diamine, propylene diamine, diethylene triamine, triethylenetetramine, amine adducts thereof, metaphenylenediamine, diaminodiphenylmethane, and diaminodiphenylsulfone.

These curing agents may be used singly or in combination.

Of these curing agents, in view of curing reactivity (reliability), preferably, phenol resin is used, and in view of balance between strength of the cured encapsulating sheet and curing reactivity, more preferably, biphenyl aralkyl resin is used.

The mixing ratio of the curing agent relative to 100 parts by mass of the kneaded material is, for example, 1 to 20 parts by mass, preferably 2 to 10 parts by mass, and the mixing ratio of the curing agent relative to 100 parts by mass of the epoxy resin is, for example, 30 to 130 parts by mass, preferably 40 to 120 parts by mass.

When phenol resin is used as the curing agent, phenol resin is added so that the number of equivalents of the hydroxyl group in the phenol resin relative to one equivalent of the epoxy group of the above-described epoxy resin is 0.5 to 2 equivalents, preferably 0.8 to 1.2 equivalents.

As necessary, the kneaded material contains, along with the curing agent, a curing accelerator.

Examples of curing accelerators include organic phosphorus compounds such as triphenyl phosphine, and tetraphenyl phosphonium.tetraphenylborate; and imidazole compounds.

These curing accelerators may be used singly or in combination.

Of these curing accelerators, organic phosphorus compounds are used, and more preferably, tetraphenyl phosphonium.tetraphenylborate is used.

The proportion of the curing accelerator content relative to 100 parts by mass of the kneaded material is, for example, 0.01 to 5 parts by mass, preferably 0.05 to 3 parts by mass.

The proportion of the curing accelerator content relative to 100 parts by mass of the curing agent is, for example, 0.5 to 10 parts by mass, preferably 1 to 5 parts by mass.

The inorganic filler is not particularly limited, and known fillers are used.

To be specific, examples include powder of quartz glass, talc, silica (e.g., molten silica, crystalline silica, etc.), alumina, aluminum nitride, silicon nitride, calcium carbonate (e.g., calcium carbonate heavy, calcium carbonate light, Hakuenka® (colloidal calcium carbonate), etc.), and titanium oxide.

These fillers may be used singly or in combination.

Of these fillers, in view of a decrease in linear expansion coefficient of the cured encapsulating sheet, preferably, silica powder is used, and more preferably, molten silica powder is used.

Examples of molten silica include spherical molten silica powder and pulverized molten silica powder. In view of flowability of the kneaded material, preferably, spherical molten silica powder is used.

Such spherical molten silica powder has an average particle size of, for example, 0.1 to 40 μm, preferably 0.1 to 30 μm, more preferably 0.3 to 15 μm.

The average particle size can be measured with, for example, a laser diffraction/scattering particle size distribution analyzer.

The mixing ratio of the filler relative to 100 parts by mass of the kneaded material is, for example, 60 to 95 parts by mass, and in view of a decrease in linear expansion coefficient of the cured encapsulating sheet, the mixing ratio of the filler relative to 100 parts by mass of the kneaded material is preferably 70 to 93 parts by mass, more preferably 85 to 90 parts by mass.

The mixing ratio of the filler relative to 100 parts by mass of the epoxy resin is, for example, 1000 to 3000 parts by mass, preferably 1300 to 2500 parts by mass.

A flexibilizer can also be added to the kneaded material, in view of an improvement in flexibility of the encapsulating sheet.

The flexibilizer is not particularly limited, as long as the flexibilizer is the one that adds flexibility to the encapsulating sheet, and examples thereof include various acrylic copolymers such as polyacrylate; elastomers having a styrene structure such as a polystyrene-polyisobutylene copolymer, and a styrene acrylate copolymer; rubber polymers such as butadiene rubber, styrene-butadiene rubber (SBR), an ethylene-vinyl acetate copolymer (EVA), isoprene rubber, and acrylonitrile rubber.

These flexibilizers may be used singly or in combination.

Of these flexibilizers, in view of heat resistance and strength of the kneaded material, preferably, an elastomer having a styrene structure is used, more preferably, a polystyrene-polyisobutylene copolymer is used.

The proportion of the flexibilizer content relative to 100 parts by mass of the kneaded material is, for example, below 30 parts by mass, and in view of adhesiveness and heat resistance, the proportion of the flexibilizer content relative to 100 parts by mass of the kneaded material is preferably below 10 parts by mass, more preferably below 5 parts by mass.

In addition to the above-described components, an epoxy resin (hereinafter referred to as an additional epoxy resin) other than the above-described epoxy resins, and further, as necessary, known additives such as a fire retardant, and pigment including carbon black can be added to the kneaded material at an appropriate proportion.

When such an additional epoxy resin is added, the proportion of such an additional epoxy resin content relative to 100 parts by mass of a total of the above-described epoxy resins and such an additional epoxy resin is, for example, below 30 parts by mass, and in view of flexibility of the encapsulating sheet, preferably below 20 parts by mass.

Such a kneaded material is prepared by blending the above-described components at the above-described mixing ratio, and melt-kneading the mixture.

The method of melt-kneading is not particularly limited, but examples include a method of melt-kneading using a known kneader including, for example, a mixing roll, a pressure kneader, and an extruder.

The conditions of kneading are as follows. The temperature is not particularly limited as long as the temperature is the softening point or more of the above-described components, and the temperature is, for example, 30 to 150° C., in view of thermosetting properties of the epoxy resin, the temperature is preferably 40 to 140° C., more preferably 60 to 120° C. The kneading time is, for example, 1 to 30 minutes, preferably 5 to 15 minutes.

A kneaded material is prepared in this manner.

Such a kneaded material is subjected to plastic working, thereby preparing an encapsulating sheet. To be specific, by subjecting the kneaded material to plastic working after the melt-kneading while the temperature is high without cooling, an encapsulating sheet is prepared.

The method of plastic working is not particularly limited, and examples thereof include flat-plate pressing, T-die extrusion, roll sheeting, roll mixing, inflation extrusion, co-extrusion, and calendering.

The plastic working temperature is not particularly limited, as long as the temperature is equal to or more than the softening point of the above-described components, and in view of thermosetting properties and workability of the epoxy resin, the plastic working temperature is, for example, 40 to 150° C., preferably 50 to 140° C., more preferably 60 to 120° C.

The encapsulating sheet is prepared in this manner.

The encapsulating sheet has a thickness of, for example, 100 to 1500 μm, preferably 300 to 1200 μm.

The encapsulating sheet of the present invention is formed by subjecting a kneaded material to plastic working, without applying a varnish containing epoxy resin and an inorganic filler on a film, etc.

Therefore, the mixing ratio of the inorganic filler can be increased, and sufficient improvement in performance of the encapsulating sheet can be achieved.

The encapsulating sheet of the present invention has sufficient flexibility without blending a large amount of flexibilizer, and therefore improvement in its adhesiveness and heat resistance can be achieved.

Thus, encapsulating sheet of the present invention can increase the mixing ratio of the inorganic filler, and allows improvement in its adhesiveness and heat resistance.

Such an encapsulating sheet is used, for example, for encapsulating electronic components on a mounting substrate. The electronic components are not particularly limited, and examples thereof include semiconductor elements, condensers, and resistance elements.

In encapsulation of electronic components on a mounting substrate with the above-described encapsulating sheet, the electronic components are encapsulated by curing the encapsulating sheet. The electronic device with electronic components encapsulated thereon is produced in this manner.

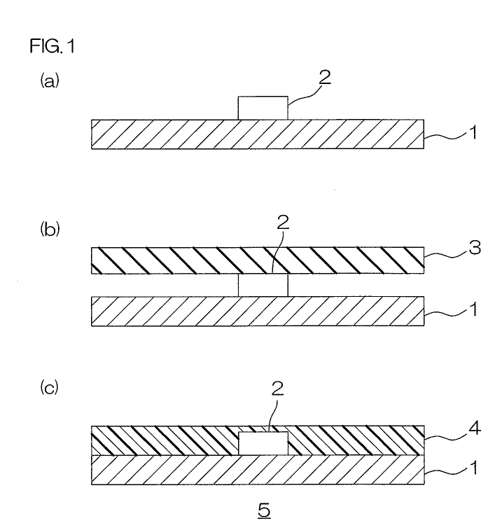

In detail, to produce an electronic device, as shown in FIG. 1 (a), first, an electronic component 2 is disposed on a mounting substrate 1 so that the electrode for connection (not shown) of the mounting substrate 1 and the electrode for connection (not shown) of the electronic component 2 are electrically connected.

The mounting substrate 1 is not particularly limited, and examples thereof include ceramic substrates composed of silicon wafer, glass, etc.; metal substrates composed of copper, aluminum, stainless steel, iron alloys, etc.; and plastic substrate composed of polyimide, glass-epoxy, etc.

Of these examples of the mounting substrate 1, preferably, plastic substrates (glass epoxy substrate) composed of glass-epoxy, etc. is used.

The electronic component 2 is not particularly limited, and examples thereof include semiconductor elements, condensers, and resistance elements.

Then, as shown in FIG. 1 (b), an encapsulating sheet 3 is disposed on the electronic component 2 placed on the mounting substrate 1.

Then, the electronic component 2 is covered by the encapsulating sheet 3 by pressing the encapsulating sheet 3 with predetermined conditions, thereby allowing the encapsulating sheet 3 to adhere to the electronic component 2 and the mounting substrate 1.

The conditions of pressing are as follows: a temperature of, for example, 40 to 120° C., preferably 50 to 100° C.; a pressure of, for example, 50 to 2500 kPa, preferably 100 to 2000 kPa; and a duration of, for example, 0.3 to 10 minutes, preferably 0.5 to 5 minutes.

In view of improvement in close adhesion and conformability of the encapsulating sheet 3, the electronic component 2, and the mounting substrate 1, preferably, the pressing is conducted under vacuum conditions.

Then, the encapsulating sheet 3 is cured under predetermined conditions at atmospheric pressure, as shown in FIG. 1 (c), thereby forming the encapsulating sheet 3 as an encapsulating resin layer 4. Then, as necessary, a dicing tape that covers the encapsulating resin layer 4 is bonded on the encapsulating resin layer 4.

The conditions of curing are as follows: a temperature of, for example, 120 to 220° C., preferably 150 to 200° C., and a duration of, for example, 10 to 150 minutes, preferably 30 to 120 minutes.

An electronic device 5 is produced by curing the encapsulating sheet 3 in the above-described manner, and encapsulating the electronic component 2.

Such an electronic device 5 is encapsulated by the above-described encapsulating sheet 3, and therefore adhesion between the encapsulating sheet 3 and the electronic component 2, and improvement in heat resistance of the electronic device 5 can be achieved.

### EXAMPLES

While in the following, the present invention is described in further detail with reference to Examples and Comparative Examples, the present invention is not limited to any of them by no means.

### Examples 1 to 6 and Comparative Examples 1 and 2

Components were blended according to the formulations shown in Table 1 (unit: mass %), and the mixture was melt-kneaded with a roll kneader at 60 to 120° C. for 10 minutes, thereby preparing a kneaded material.

Then, the obtained kneaded material was formed into a sheet by flat-plate pressing, thereby forming an encapsulating sheet having a thickness of 500 to 1000 μm.

### Comparative Example 3

Components were blended according to the formulation shown in Table 1 (unit: mass %), and methyl ethyl ketone in an amount that equals the total amount of the components was added, thereby preparing a varnish for sheet coating.

Then, the obtained varnish for sheet coating was applied and dried on a release-treated surface of a polyester film A (manufactured by Mitsubishi Polyester Film GmbH, MRF-10) having a thickness of 50 μm with a comma coater so that the thickness of the coating after drying was 50 μm.

Then, the release-treated surface of a polyester film B (manufactured by Mitsubishi Polyester Film GmbH, MRX-38) having a thickness of 38 μm was placed on the dried varnish for sheet coating so as to sandwich the dried varnish for sheet coating, thereby preparing a sheet resin composition.

Thereafter, the polyester film A and the polyester film B were appropriately released, and the resin composition in sheet form was laminated to form four layers using a roll laminator, thereby preparing an encapsulating sheet having a thickness of 200 μm.

### Comparative Example 4

An encapsulating sheet was prepared in the same manner as in Comparative Example 3 by blending the components according to the formulations shown in Table 1 (unit: mass %).

As a result, segregation of the inorganic filler generated, the coating could not be formed, and therefore the encapsulating sheet could not be prepared.

Evaluation

The obtained encapsulating sheets of Examples and Comparative Examples were evaluated in flexibility and adhesiveness test as follows.

### (1) Flexibility Test

The encapsulating sheets of Examples and Comparative Examples were cut out into a size (width 60 mm×length 60 mm), and the sheets were slowly bent 90° with widthwise both end portions thereof being held. The flexibility was evaluated based on the following criteria. The results are shown in Table 1.

Excellent: Not broken even bent 90°
Good: Cracked when bent 90°
Bad: Broken when bent 90°

### (2) Adhesiveness Test

Encapsulating sheets (width 10 mm×length 40 mm×thickness 0.2 mm) of Examples and Comparative Examples were laminated on glass epoxy substrates (width 10 mm×length 40 mm×thickness 0.3 mm).

Then, portions of the encapsulating sheet protruded from the glass epoxy substrate were removed. Then, the glass epoxy substrates with the encapsulating sheets laminated thereon were heated to 90° C., and silicon chips (3 mm²×thickness 0.625 mm) were mounted on the encapsulating sheets.

Then, the encapsulating sheet was cured under conditions of a temperature of 175° C. and a duration of 1 hour.

A load was applied from the side face of the silicon chip at 25° C. or at 260° C. using the multipurpose bondtester (manufactured by Dage Japan Co. Ltd.), and the load at which the silicon chip was detached from the glass epoxy substrate was determined.

Evaluation criteria are as follows. At 25° C., those silicon chips that were detached from the glass epoxy substrate at a load of below 6 MPa were regarded as Bad; at a load of 6 to 10 MPa were regarded as Good; and at a load in excess of 10 MPa were regarded as Excellent.

At 260° C., those silicon chips that were detached from the glass epoxy substrate at a load of below 1 MPa were regarded as Bad; at a load of 1 to 3 MPa were regarded as Good; and at a load in excess of 3 MPa were regarded as Excellent.

The results are shown in Table 1.

TABLE 1

| | | | Examples | | | | | | Comparative Examples | | | |
|---|---|---|---|---|---|---|---|---|---|---|---|---|
| | | | 1 | 2 | 3 | 4 | 5 | 6 | 1 | 2 | 3 | 4 |
| Kneaded | Epoxy Resin | (a) | 5.8 | 4.0 | 4.0 | — | — | 5.4 | — | — | — | 4.0 |
| Material | | (b) | — | — | — | 5.2 | — | — | — | — | — | — |
| Formulation | | (c) | — | — | — | — | 5.1 | — | — | — | — | — |
| (mass %) | | (d) | — | — | — | — | — | — | 4.0 | — | — | — |
| | | (e) | — | — | — | — | — | — | — | 5.8 | — | — |
| | | (f) | — | — | — | — | — | — | — | — | 6.0 | — |
| | | (g) | — | — | — | — | — | — | — | — | 2.6 | — |
| | Phenol resin | (a) | 6.1 | 4.3 | 4.3 | 3.1 | 3.2 | — | 4.2 | 2.5 | — | 4.3 |
| | | (b) | — | — | — | — | — | 2.9 | — | — | 3.0 | — |
| | Inorganic Filler | | 88.0 | 88.0 | 88.0 | 88.0 | 88.0 | 88.0 | 88.0 | 88.0 | 60.0 | 88.0 |
| | Curing | | 0.1 | 0.1 | 0.1 | 0.1 | 0.1 | 0.1 | 0.1 | 0.1 | 0.1 | 0.1 |
| | Accelerator | | | | | | | | | | | |
| | Flexibilizer | (a) | — | 3.6 | — | 3.6 | 3.6 | 3.6 | 3.6 | 3.6 | — | 3.6 |
| | | (b) | — | — | 3.6 | — | — | — | — | — | 28.0 | — |

| Coating Forming Method | | Plastic | Plastic | Plastic | Plastic | Plastic | Plastic | Plastic | Plastic | Varnish | Varnish |
|---|---|---|---|---|---|---|---|---|---|---|---|
| | | Working | Working | Working | Working | Working | Working | Working | Working | Coating | Coating |
| Evaluation | Flexibility | Excellent | Excellent | Excellent | Excellent | Excellent | Good | Bad | Bad | Excellent | — |
| | 25° C. | Excellent | Excellent | Good | Excellent | Excellent | Excellent | Excellent | Excellent | Bad | — |
| | Adhesiveness | | | | | | | | | | |
| | (MPa) | | | | | | | | | | |
| | 260° C. | Excellent | Good | Good | Good | Good | Good | Good | Good | Bad | — |
| | Adhesiveness | | | | | | | | | | |
| | (MPa) | | | | | | | | | | |

Abbreviations in Table 1 are shown below.

Epoxy resin (a): bisphenol F epoxy resin (epoxy equivalent 200 g/eq., softening point 80° C.) represented by Chemical Formula (2) above
Epoxy resin (b): 4,4′-thio bisphenol epoxy resin (epoxy equivalent 170 g/eq., softening point 44° C.) represented by Chemical Formula (5) above
Epoxy resin (c): 4,4′-oxybisphenol epoxy resin (epoxy equivalent 164 g/eq., softening point 83° C.) represented by Chemical Formula (8) above
Epoxy resin (d): biphenyl epoxy resin (epoxy equivalent 193 g/eq. softening point 105° C.) represented by Chemical Formula (11) below

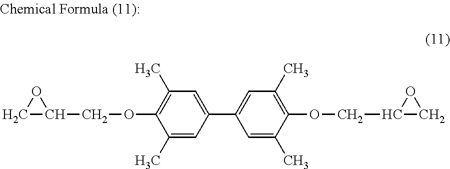

Epoxy resin (e): epoxy resin (epoxy equivalent 244 g/eq., softening point 113° C.) represented by Chemical Formula (12) below

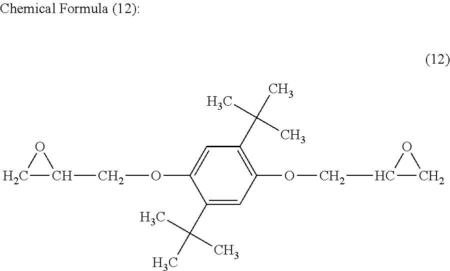

Epoxy resin (f): modified bisphenol A epoxy resin (manufactured by DIC corporation, EPICLON EXA-4850-150, hydroxyl equivalent 447 g/eq. liquid)
Epoxy resin (g): triphenylmethane epoxy resin (manufactured by NIPPON KAYAKU Co., Ltd, EPPN-501HY, hydroxyl equivalent 169 g/eq., softening point 60° C.)
Phenol resin (a): phenol resin (manufactured by MEIWA PLASTIC INDUSTRIES, LTD., MEH7851SS, hydroxyl equivalent 203 g/eq., softening point 67° C.) having a biphenyl aralkyl structure
Phenol resin (b): phenol novolak resin (manufactured by Gunei Chemical Industry Co., Ltd., GS-200, hydroxyl equivalent 105 g/eq., softening point 100° C.)
Inorganic filler: spherical molten silica powder (manufactured by DENKI KAGAKU KOGYO KABUSHIKI KAISHA, FB-9454, average particle size 20 μm)
Curing accelerator: tetraphenylphosphonium.tetraphenylborate
Flexibilizer (a): polystyrene-polyisobutylene copolymer
Flexibilizer (b): acrylic copolymer (Composition: butyl acrylate:acrylonitrile:glycidylmethacrylate=85:8:7 (weight ratio))(weight-average molecular weight 800,000)

While the illustrative embodiments of the present invention are provided in the above description, such is for illustrative purpose only and it is not to be construed as limiting the scope of the present invention. Modifications and variations of the present invention that will be obvious to those skilled in the art are to be covered by the following claims.

What is claimed is:

1. An encapsulating sheet obtained by subjecting a kneaded material to plastic working,
the kneaded material comprising
an epoxy resin represented by General Formula (1) below,
a curing agent, and
an inorganic filler, 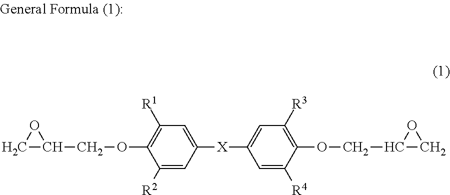
(where R¹ to R⁴ are the same or different and each represents a methyl group or a hydrogen atom; and X represents —CH₂—, —O—, or —S—).

2. The encapsulating sheet according to claim 1, wherein the curing agent is a phenol resin having a biphenyl aralkyl structure.

3. The encapsulating sheet according to claim 1, wherein the kneaded material further comprises a flexibilizer kneaded therein.

4. The encapsulating sheet according to claim 3, wherein the flexibilizer is an elastomer having a styrene structure.

5. An electronic device obtained by encapsulating an electronic component by curing an encapsulating sheet,
wherein the encapsulating sheet is obtained by subjecting a kneaded material to plastic working,
the kneaded material comprising
an epoxy resin represented by General Formula (1) below,
a curing agent, and
an inorganic filler, 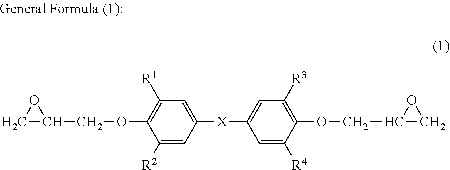
(where R¹ to R⁴ are the same or different and each represents a methyl group or a hydrogen atom; and X represents —CH₂—, —O—, or —S—).
